(19) United States
(12) Patent Application Publication
(10) Pub. No.: US 2016/0335634 A1
(43) Pub. Date: Nov. 17, 2016

(54) Method and System for Partial Approval of Virtual Card Transactions

(71) Applicant: MasterCard International Incorporated, Purchase, NY (US)

(72) Inventor: Eoin FLOOD, Dublin (IE)

(73) Assignee: MASTERCARD INTERNATIONAL INCORPORATED, Purchase, NY (US)

(21) Appl. No.: 14/712,286

(22) Filed: May 14, 2015

(51) Int. Cl. G06Q 20/40

(52) U.S. Cl. CPC G06Q 20/409

(57) ABSTRACT

A method and system for enabling partial payment by a controlled card, wherein the method includes: storing, in a database, a plurality of account profiles, wherein each account profile includes at least a controlled card account identifier and data related to at least one control associated with the controlled card account identifier; receiving an authorization request for a payment transaction via a payment network, wherein the authorization request includes at least a single controlled card account identifier associated with one of the plurality of controlled card account profiles and transaction data; generating at least one recommended approval value based upon the at least one control associated with the single controlled card account identifier; updating the authorization request to include information in one or more data fields that corresponds with the at least one recommended approval value; and transmitting the updated authorization request.

### FIELD

The present disclosure relates to the processing of controlled payment number transactions, specifically methods and systems for enabling partial approval of controlled card transactions.

### BACKGROUND

The use of credit cards as a form of payment is prevalent in today's society. To avoid the hassle of monitoring and keeping up with bills from multiple accounts, often multiple cards associated with a shared credit card account may be distributed to several users. For instance, multiple family members or several employees of a company may each possess a single card, and each family member or employee may then use the card in his or her possession to draw funds from or charge transactions to the shared account. But, a parent or company may not wish to give unbridled access to each cardholder. To allow for control of an individual cardholder's usage, payment cards have been developed that include various controls.

For example, Mastercard® has developed the inControl™ platform to allow an account owner to create custom controls for controlled payment cards, also known as controlled payment numbers (CPNs). The account owner may place various limits on each controlled payment number, such as limits related to: the amount of overall spending, the amount of spending on a single transaction, the amount of spending on a type of transaction, the eligible merchants at which the CPN may be used, the number of transactions within a given time period, and a variety of other controls. The introduction of CPNs has greatly enhanced an account owner's ability to control the circumstances under which a card is used and has also provided for greater protection from fraud and theft.

A controlled payment number may be associated with a traditional payment card or be a virtual card number (VCN). The use of VCNs has increased in recent years, particularly with the rise in purchasing of goods and services over the internet. Virtual card numbers offer increased flexibility over traditional payment cards due to their capability of being electronically issued and distributed.

In some instances, virtual card numbers may be issued for “one-time use” or “limited use.” For example, many companies issue VCNs to their customers as a compensatory or reward voucher which can be used to make new purchases, from that same company or another entity. Such VCNs may be CPNs associated with particular rules. A problem may arise, where a customer issued a limited use VCN may wish to purchase an item exceeding an allowable purchase limit placed on the VCN.

Until now, when a customer attempted to use a controlled payment number, such as a limited use VCN, to pay for a purchase that exceeded one or more limits placed on that CPN, the transaction would be rejected, since partial approval has not, in the past, been supported for CPNs. Such a problem represents a lost opportunity for: (1) the company that issued the virtual card number, since it cannot sell the additional goods or services the consumer attempted to purchase with the VCN; (2) the customer, since he or she could not make the intended purchase and may have to settle for an alternative product due to the limited validity of the VCN; and, (3) the issuer, since the rejection amounts to loss of revenue.

Additionally, while some merchants may offer to split a transaction at the point-of-sale, a cardholder may not necessarily be aware of the limit for a particular transaction or transaction type associated with his or her controlled payment number. In such an instance, the cardholder is left to guess at a purchase value for which the transaction may be approved or whether any such purchase value exists, or have to look it up through an issuer website or the like. This inhibits the cardholder's ability to take full advantage of the card and may also result in a frustrating trial and error process, in which the cardholder must make multiple attempts to use the card for different purchase amounts or transaction types until one happens to satisfy the unknown limits and is then approved.

Thus, there is a need for a technical solution to improve the processing of controlled payment number transactions. Particularly, there is a need to provide for a method of processing a transaction associated with a controlled payment number that allows for the approval of a transaction in the amount of an allowable value associated with one or more controls on the controlled card number, even if the total transaction amount exceeds the allowable value or some portion of the transaction violates another control. By allowing for such partial approval of a transaction associated with a controlled payment number, the method and system of the present disclosure may avoid the aforementioned problems of wasted time and revenue. Further, the enablement of partial approval for controlled payment card transactions will increase the overall number of approved controlled payment card transactions, translating into higher revenue.

### SUMMARY

The present disclosure provides a description of methods and systems for the partial approval of payment transactions involving a controlled payment number.

A method for enabling partial payment by a controlled card includes: storing, in a controlled card database, a plurality of controlled card account profiles, wherein each controlled card account profile includes at least a controlled card account identifier and data related to at least one control associated with the controlled card account identifier; receiving, by a receiving device, an authorization request for a payment transaction via a payment network, wherein the authorization request includes at least a single controlled card account identifier associated with one of the plurality of controlled card account profiles and transaction data; generating, by a processing device, at least one recommended approval value based upon the at least one control associated with the single controlled card account identifier; updating, by the processing device, the authorization request to include information in one or more data fields that corresponds with the at least one recommended approval value; and transmitting, by a transmitting device and via the payment network, the updated authorization request.

A system for enabling partial payment by a controlled card includes a controlled card database, a receiving device, a processing device, and a transmitting device. The controlled card database is configured to store controlled card profiles. Each stored controlled card profile includes at least a controlled card account identifier and data related to a control associated with the controlled card account identifier. The receiving device is configured to receive an authorization request for a payment transaction via a payment network. The received authorization request includes at least one controlled card account identifier associated with one of the plurality of controlled card account profiles and transaction data. The processing device is configured to generate at least one recommended approval value based upon the at least one control associated with the controlled card account identifier and update the authorization request to include information in one or more data fields that corresponds with the generated recommended approval value. The transmitting device is configured to transmit the updated authorization request via the payment network. The transmitted updated authorization request may include at least the single controlled card account identifier, transaction data, and the one or more data fields including information corresponding to the recommended approval value.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for partial payment processing in controlled payment number transactions in accordance with exemplary embodiments.

FIG. 2 is a block diagram illustrating the processing server 110 of FIG. 1 for enabling partial payment processing in controlled payment number transactions in accordance with exemplary embodiments.

FIG. 3 is a flow diagram illustrating a process for the processing of controlled payment number transactions using the processing server 110 of FIG. 2 in accordance with exemplary embodiments

FIG. 4 is a flow chart illustrating generalized steps carried out by the processing server 110 of FIG. 2 in accordance with exemplary embodiments.

FIG. 5 is a flow chart illustrating an exemplary method for enabling partial payment in controlled payment number transactions.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity and the physical payment network, such as the equipment, hardware, and software comprising the payment network.

Payment Account—A financial account that may be used to fund a transaction, such as a checking account, savings account, credit account, virtual payment account, etc. A payment account may be associated with a consumer or an account owner, which may be any suitable type of entity associated with a payment account, such as a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant or it may be data representing the associated payment account (e.g., data stored in a communication device, such as a smart phone or computer). In some instances, a payment card may be a number associated with a payment account, not tied to a physical card or device. A check may be considered a payment card, where applicable.

Controlled Payment Number—Controlled payment numbers may be payment numbers associated with a payment account that are subject to one or more rules. In many cases, these rules may be set by an account owner and may offer controls on various spending limits, limits on days and/or times of transactions, transaction amount limits for specified merchants or industries, transaction spending or frequency limits, transaction controls related to geographic location, etc. In some instances, the rules may be set by an entity, or multiple entities, other than the account owner. Controlled payment numbers may offer an account owner an opportunity to provide multiple payment cards tied to the account to multiple users, subject to rules set by the account owner. Each of the multiple payment cards may be associated with at least one rule as the other multiple payment cards. Alternatively, or in addition, each of the multiple payment cards may be associated with at least one rule unique to that payment card, or a rule common to some, but not all, of the multiple payment cards. Controlled payment numbers are useful in scenarios such as those in which an employer distributes cards to employees or those in which a parent distributes cards to children. Controlled payment numbers may be associated with a physical card or they may be virtual. Additional detail regarding controlled payment numbers and placing controls on consumer spending can be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 8,756,150, issued Jun. 17, 2014; U.S. Pat. No. 8,639,623, issued Jan. 28, 2014; U.S. Pat. No. 8,527,416, issued Sep. 3, 2013; U.S. Pat. No. 8,510,218, issued Aug. 13, 2013; U.S. Patent Application No. 2007/0276736, published Nov. 29, 2007; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

System for Partial Approval of Virtual Card Transactions

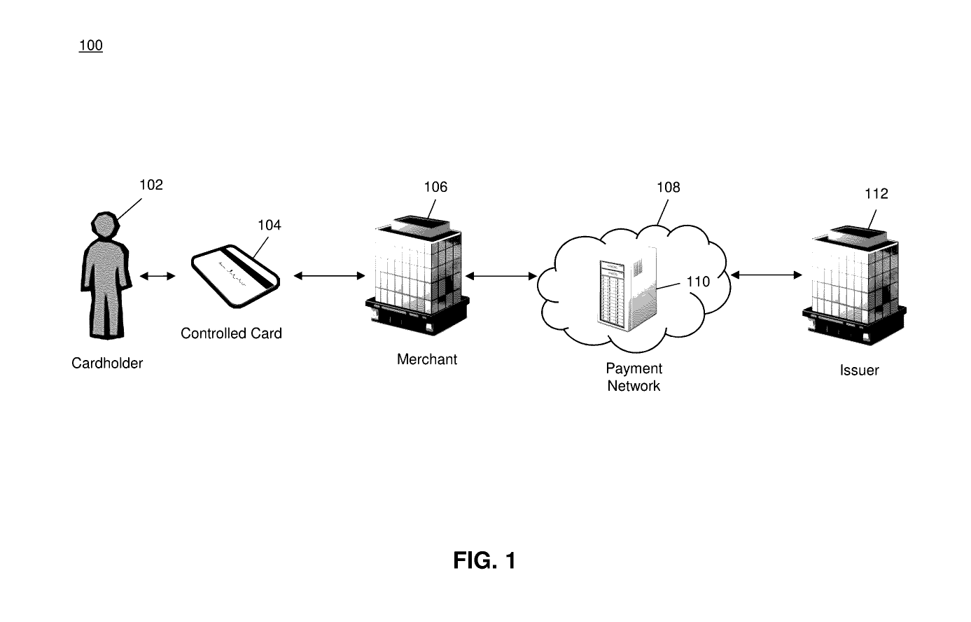

FIG. 1 illustrates a system 100 for processing partial approval of financial transactions funded via a controlled payment number.

In the system 100, a cardholder 102 may possess a controlled card 104. The controlled card 104 is a payment card. The controlled card 104 may be issued by an issuer 112, which may be a computer system and distribution system of a financial institution configured to issue payment cards to consumers on one or more payment accounts, such as at an issuing bank. The controlled card 104 may be subject to one or more controls, and may therefore be considered to be associated with a controlled payment number (CPN). The controlled card 104 may be, but is not necessarily, a virtual card number (VCN).

Controls on the controlled card 104 may be set by the cardholder 102, an entity other than the cardholder (not pictured), or the issuer 112. For example, the issuer 112 may set controls on the controlled card 104 as part of an agreement in the establishing of the related payment account. In some instances the cardholder may set controls on the payment card 104 instead of, or in addition to, the controls set by the issuer 112 through, for instance, a mobile or other digital or voice interface with the issuer 112. In some instances, an entity other than the cardholder may set controls instead of, or in addition to, the controls set by the issuer 112 and/or the cardholder 102.

The entity other than the cardholder may be an account owner or any suitable type of entity associated with a payment account, which may include a person, family, company, corporation, government entity, etc. In one exemplary embodiment, an employer corporation may set controls on a controlled card of a cardholder employee. In another exemplary embodiment, an account owner may gift a controlled card number, which may be a virtual card number, to a cardholder as a gift card.

In an exemplary embodiment, controls may be managed and enforced by a payment network 108 configured to process payment transactions funded via the controlled card 104. Controls may be set by the cardholder 102 and/or the issuer 112 and/or an entity other than the cardholder by providing requested controls to the payment network 108 using methods and systems that will be apparent to persons having skill in the relevant art.

The payment network 108 may include a processing server 110. The processing server 110, discussed in more detail below, may be configured to process payment transactions where controlled cards 104 are used to fund the transaction. Transactions where controlled cards 104 are used to fund the transaction, may be referred to as “controlled payment number transactions” or “controlled payment transactions.” The cardholder 102 may use the controlled card 104, which may be a CPN subject to one or more controls registered with the payment network 108 and/or processing server 110, at a merchant 106, to fund a payment transaction. The merchant 106 may read the card details of the controlled card 104 using methods and systems that will be apparent to one having skill in the relevant art. The merchant 106 may then submit an authorization request to the payment network 108 for the controlled payment transaction. The authorization request may be submitted from the merchant 106 directly to the payment network 108 or via another entity, such as an acquirer (not pictured).

The payment network 108 may receive the authorization request, which may then be processed by the processing server 110 using the methods discussed herein. The processing server 110 may scan the controls associated with the controlled card 104. The processing server 110 may then generate at least one recommended approval value corresponding to the at least one identified control. The recommended approval value may be the entire available balance associated with the controlled card 104 or a balance less than the entire available balance. The processing server 110 may then update the authorization request to include information in one or more data fields that corresponds to the at least one recommended approval value.

In one embodiment, the authorization request may be formatted pursuant to the International Organization for Standardization's ISO 8583 standard and the information included in the one or more data fields may be a new value or values included in an existing field provided by the ISO 8583 standard. Additional methods for including the recommended approval value information in the updated authorization request will be apparent to persons having skill in the relevant art.

By providing means for partial approval of a payment transaction funded by a controlled payment number, the processing server 110 may allow for improved processing of controlled payment transactions. As a result, more controlled payment transactions may be processed successfully without requiring multiple authorization requests or estimation of the limit associated with the controlled payment transaction. Thus, increased cardholder 102, merchant 106 and issuer 112 satisfaction may be achieved and a greater number of controlled payment transactions may be processed, thereby increasing revenue for the payment network 108, issuers 112, and merchants 106.

Processing Server

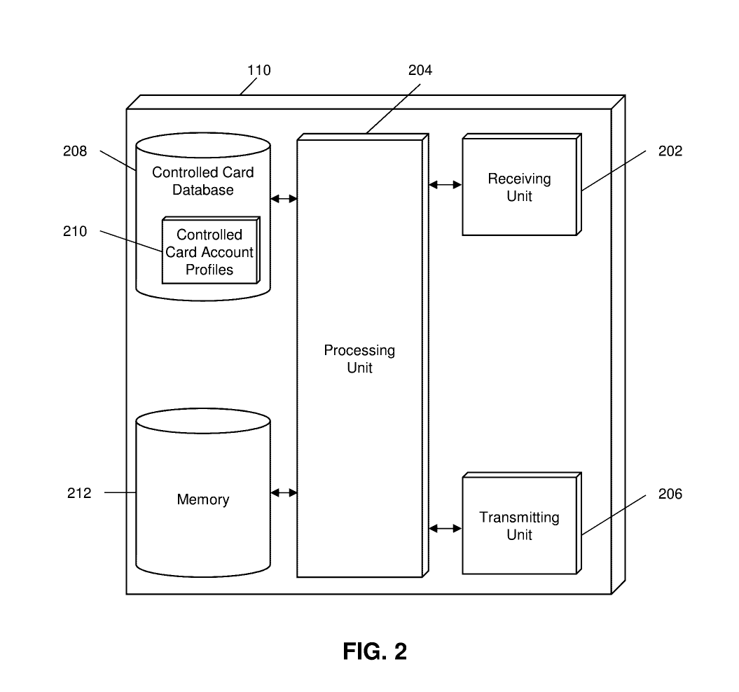

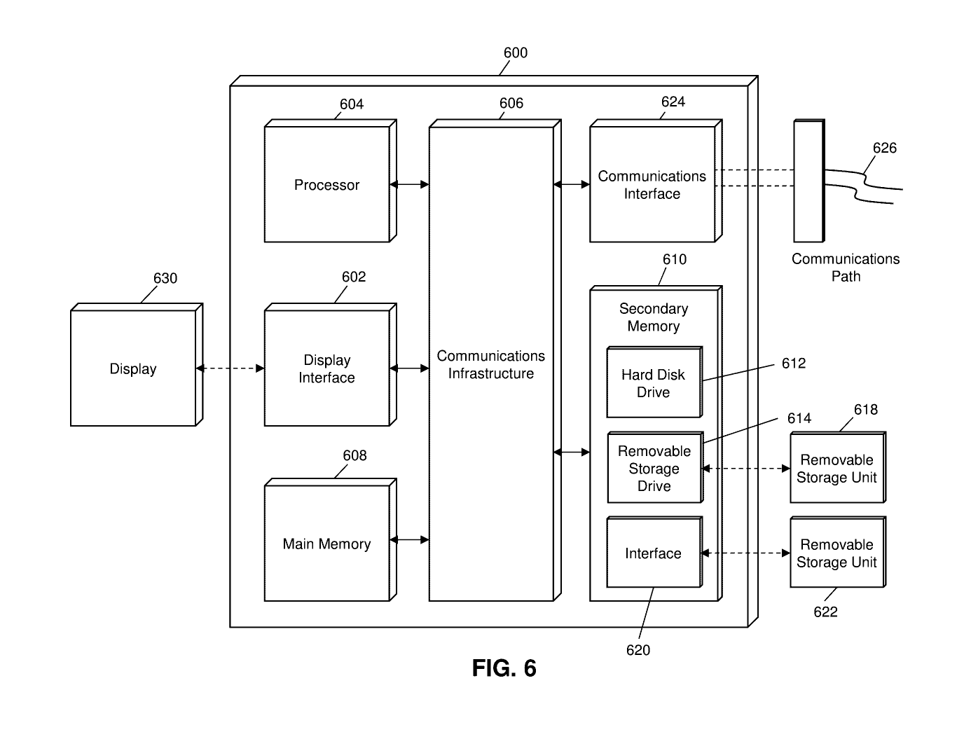

FIG. 2 illustrates an embodiment of the processing server 110 of the system 100. It will be apparent to persons having skill in the relevant art that the embodiment of the processing server 110 illustrated in FIG. 2 is provided as an illustration only and may not be exhaustive as to all possible configurations of the processing server 110 suitable for performing the functions discussed herein. For example, the computer system 600 illustrated in FIG. 6 and discussed in more detail below may be a suitable configuration of the processing server 110.

The processing server 110 may include a receiving unit 202. The receiving unit 202 may be configured to receive data over one or more networks via one or more network protocols. The receiving unit 202 may receive account details from the issuer 112 for one or more payment accounts. Account details may include at least a payment account number associated with a payment account, which may be used in the processing of payment transactions funded by the associated payment account. Account details may further include a payment account identifier. The receiving unit 202 may also be configured to receive controlled payment number requests and one or more account controls from the issuer 112, cardholder 102, or an entity other than the cardholder associated with the payment account. Controlled payment number requests may include at least an account identifier associated with the payment account for which the controlled payment number is requested.

The processing server 110 may include a controlled card database 208. The controlled card database 208 may be configured to store a plurality of controlled card account profiles 210. Each controlled card account profile 210 may include data related to a payment account including at least the payment account number associated with the related payment account. The controlled card account profile 210 may also include an account identifier. The account identifier may be a unique value suitable for identification of the controlled card account profile 210 and may be the payment account number itself, or another suitable value, such as an identification number, username, e-mail address, etc.

The processing server 110 may further include a processing unit 204. The processing unit 204 may be configured to perform the functions of the processing server 110 discussed herein, as will be apparent to persons having skill in the relevant art. When a controlled payment number request is received by the receiving unit 202, the processing unit 204 may identify a controlled card account profile 210 in the controlled card database 208 associated with the controlled payment number request, such as by using the account identifier included therein. The processing unit 204 may then identify a controlled payment number to be issued to the cardholder 102 that is subject to the one or more account controls included in the received controlled payment number request. In some embodiments, each controlled card account profile 210 may be associated with a single CPN. In some embodiments, each controlled card account profile 210 may be associated with a single payment account, and may include data related to a plurality of CPNs that are associated with the single payment account.

The processing server 110 may also include a transmitting unit 206. The transmitting unit 206 may be configured to transmit data over one or more networks via one or more network protocols. The transmitting unit 206 may transmit the identified CPN to the cardholder 102 or the issuer 112 for use. The transmitting unit 206 may transmit the identified CPN to an entity other than the cardholder, such as an account owner, and then the account owner may provide the CPN to the cardholder 102. The CPN may be transmitted as a virtual payment card or as a physical payment card that is issued to the cardholder 102 using traditional methods and systems. Where the CPN is transmitted as a virtual payment card, it may be transmitted to a computing device associated with the cardholder 102. The identification and/or generation of CPNs and the issuing of payment cards (both physical and virtual) associated with the CPNs will be apparent to persons having skill in the relevant art.

The receiving unit 202 may be further configured to receive authorization requests for controlled payment transactions. Authorization requests may include transaction data, such as a transaction amount, transaction time and/or date, geographic location, product data, merchant data, point-of-sale data, offer data, loyalty data, etc. Authorization requests may further include a controlled card account identifier, such as a CPN, associated with the controlled card 104 used to fund the controlled payment transaction. The processing unit 204 may be configured to identify a controlled account profile 210 in the controlled card database 208 that is associated with the CPN included in an authorization request. The processing unit 204 may then identify whether the payment transaction should be approved or denied based upon the one or more account controls associated with the CPN.

As noted above, CPNs may be associated with one or more rules limiting the use thereof. For instance, a CPN may be associated with a rule limiting the merchants from which the CPN may be used to purchase goods or services. A cardholder 102 may attempt to use a controlled card 104 at a merchant 106. The merchant 106 may send an authorization request to the processing server 110, of the payment network 108. If the merchant 106 that sends the authorization request, violates the rule limiting the merchants from which the CPN may be used to purchase goods or services, the processing unit 204, of the processing server 110, may deny the transaction. Denial of the payment transaction may include transmitting, by the transmitting unit 206 and to the merchant 106, an authorization response indicating denial of the payment transaction. The authorization response may be transmitted directly to the merchant, or via another entity, such as an acquirer. In some instances, the authorization request may be forwarded to the issuer 112 as during traditional processing of payment transactions, with a recommendation to deny the payment transaction due to the violated rule.

In the example of the previous paragraph, if the merchant 106 that sends the authorization request does not violate the rule limiting the merchants from which the CPN may be used (i.e., the merchant is a permissible merchant), the processing unit 204, of the processing server 110, may determine if any additional rules are associated with the CPN. Additional rules may, for instance, include transaction amount limits. The processing unit 204 may determine the maximum amount permitted to be used at merchant 106, wherein the maximum amount does not violate any rules associated with the CPN. The processing unit 204 may generate at least one recommended approval value corresponding to the determined maximum amount permitted for use at merchant 106. The processing unit 204 may then update the authorization request to include information in one or more data fields that corresponds with at least one recommended approval value. The transmitting unit 206 may then transmit the updated authorization request to the issuer 112 for approval. The issuer 112 may then determine whether to approve the transaction for a value of the full transaction amount, approve the transaction for one of the at least one recommended approval values, or deny the transaction.

In some instances, the transaction data received may include items which may not be purchased with the controlled card used in the transaction, but may further include items allowed to be purchased with the controlled card. In such an instance, the recommended approval value will depend upon only those items allowed to be purchased. In some instances, the recommended approval value will be a total available balance associated with the CPN. In some instances, the recommended approval value will be an amount subject to one or more control transaction limits associated with one or more of the items allowed to be purchased.

It should be noted that the example scenarios provided above are not limiting and that CPN controls may include conditions other than, or in addition to, limitations on merchants or products. Controls on CPN use conditions may include authorized users, prohibited users, authorized merchants, prohibited merchants, authorized transaction amounts, authorized dates and/or times, transaction amount limits, number of transaction limits, aggregate transaction amount limits, geographic restrictions, etc. Additional information on the types of conditions that can control CPN usage can be found above, in the Glossary of Terms section of this Application, particularly within the description of Controlled Payment Numbers and the references cited therein.

The processing server 110 may also include the memory 212. The memory 212 may be configured to store data suitable for performing the functions of the processing server 110 discussed herein. For example, the memory 212 may be configured to store rules and/or algorithms for the generation and identification of CPNs, for the calculation of controlled card account control values, for the application of controls to a controlled card account and payment transaction, for the management of transaction processing, etc. Additional data that may be stored in the memory 212 will be apparent to persons having skill in the relevant art.

It will be apparent to persons having skill in the relevant art that the processing server 110 may include additional and/or alternative components to those illustrated in FIG. 2 and discussed herein, and that the components illustrated in FIG. 2 may be further configured to perform additional functions. For example, the components of the processing server 110 may be further configured to perform additional functions necessary for the processing of payment transactions such as the transmitting and receiving of authorization requests and responses to and from issuers 112, functions necessary for the processing and application of fraud rules, etc.

Partial Approval of Virtual Card Transactions

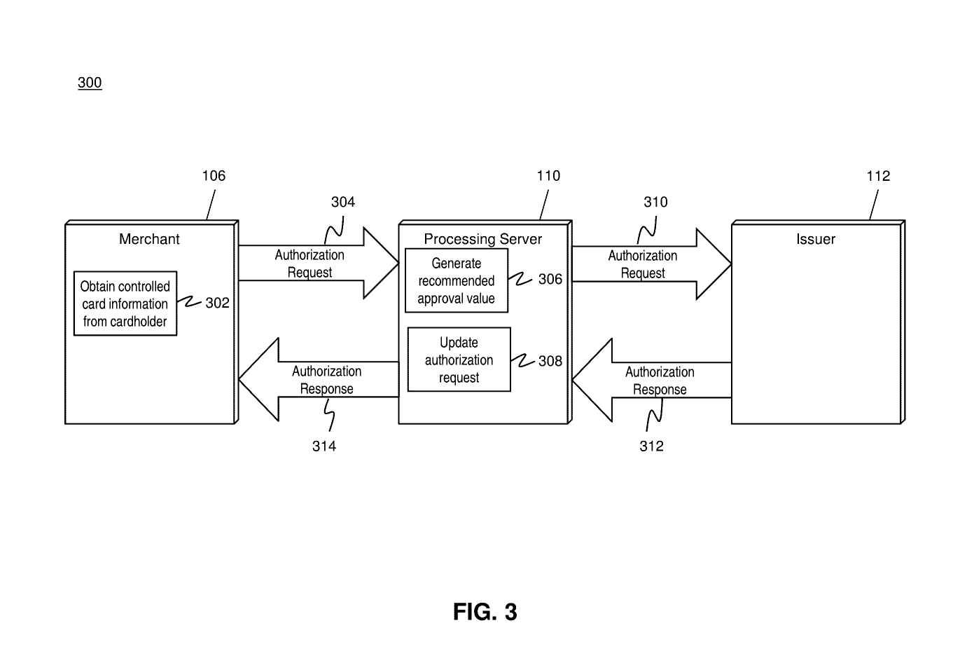

FIG. 3 illustrates a method 300 for the processing of transactions associated with a controlled card 104, wherein an authorization request 304 for a total transaction amount may be updated by a processing server 110 to allow for partial approval of the total transaction amount.

In step 302, the cardholder 102 may provide a controlled card 104 associated with a controlled payment number for funding of a financial transaction to the merchant 106. In an exemplary embodiment, the CPN may be a VCN, provided by the cardholder 102 to an employee of the merchant (not pictured). The merchant employee may input the virtual payment number into a point-of-sale device (not pictured) of the merchant 106. The virtual payment number presented by the cardholder 102 may be encoded in a machine-readable code. In such an instance, a merchant employee may employ a reader device of the merchant point-of-sale device to read the virtual payment number. The virtual payment number may be presented by the cardholder 102 directly to a merchant 106 by means of a user interface, such as through a website operated by the merchant 106. Additional methods for the providing of a controlled payment number for funding a financial transaction will be apparent to persons having skill in the relevant art.

Subsequent to step 302, the merchant 106 may transmit an authorization request 304 for authorizing the controlled payment transaction to the processing server 110. The merchant 106 may transmit the authorization request 304 directly to the processing server 110 or via another entity, such as an acquirer (not pictured). The authorization request 304 may include at least a controlled card account identifier and transaction data. The transaction data may be any data related to the transaction, such as a transaction amount, transaction time and/or date, geographic location, product data, merchant data, point-of-sale data, offer data, loyalty data, etc.

The processing server 110 may receive the authorization request 304 from the merchant 106. The processing server 110 may identify a controlled card account profile associated with the controlled card account identifier of the received authorization request 304 and determine the controls associated with the controlled card account identifier. If the transaction data included in the authorization request 304 received by the processing server 110 violates one or more controls associated with the controlled card account identifier provided by the cardholder 102, then the processing server 110 will determine if there is a manner in which to process the transaction without violating the one or more controls.

In step 306, the processing server 110 generates at least one recommended approval value based upon at least one allowable transaction amount associated with the controlled card account identifier included in the authorization request 304. The at least one recommended approval value may be the at least one allowable transaction amount, a value less than the allowable transaction amount, or a value based on a function of multiple allowable transaction amounts so long as the at least one recommended approval value does not violate any controls associated with the controlled card identifier included in the authorization request 304.

In step 308, the processing server 110 updates the authorization request to include the at least one recommended approval value generated in step 306. The processing server 110 transmits the updated authorization request 310 to the issuer 112.

The issuer 112 may receive the authorization request 310 and respond thereto. The issuer may authorize or deny the transaction associated with the authorization request 310. The issuer may authorize the total transaction amount or the issuer may authorize a transaction amount equal to one of the at least one recommended approval values included in authorization request 310. In some instances, the issuer may authorize a transaction amount less than one of the at least one recommended approval values included in authorization request 310. The issuer may transmit an authorization response 312 to the processing server 110. The processing server may transmit an authorization response 314 to the merchant 106, either directly or via an acquirer (not pictured).

In some instances, the processing server 110 may be unable to generate a recommended approval value because a value may not exist that allows for satisfaction of all rules associated with a controlled card account identifier included in an authorization request 304. In such instances, the processing server 110 may update the authorization request in step 308 to include a recommendation for denying the transaction. The updated authorization request 310 including the recommendation for denying the transaction may be forwarded to the issuer 112. The issuer 112 may respond to the authorization request 310 by transmitting an authorization response 312 to the processing server 110. The processing server 110 may transmit the authorization response 314 to the merchant 106.

In some instances where the processing server 110 may be unable to generate a recommended approval value because an allowable value may not exist, the processing server 110 may receive the authorization request 304 and transmit the authorization response 314, without forwarding an updated authorization request 310 to the issuer 112. In such instances, the authorization response 314 is a response denying the controlled payment transaction.

Processing for Partial Approval of Controlled Payment Transactions

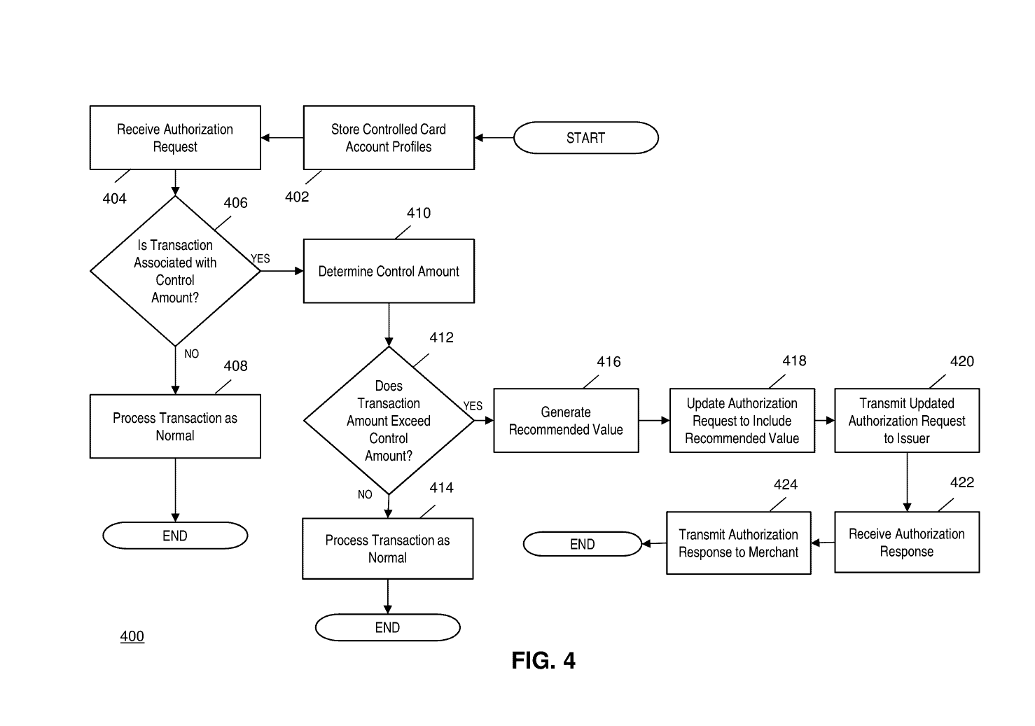

FIG. 4 illustrates an exemplary process 400 for the processing of a controlled payment transaction using the processing server 110 of FIG. 1.

In step 402, the controlled card account profiles 210 may be stored in the controlled card database 208. The controlled card account profiles 210 may include data related to a payment account including at least an account identifier associated with a CPN and one or more controls. In step 404, the receiving unit 202 of the processing server 110 may receive an authorization request for a payment transaction. The authorization request may include at least transaction data and a controlled card account identifier associated with a CPN being used to fund the payment transaction.

In step 406, the processing server 110 may determine whether a transaction amount limit is associated with the transaction data received in the authorization request. The processing server 110 may use the controlled card account identifier received in step 404 to identify the controlled card account profile 210 corresponding to the received controlled card account identifier and determine whether any conditions associated with the controlled card account profile 210 apply to the received transaction data. And, if so, the processing server may determine whether any conditions associated with the controlled card account profile 210 specify transaction amount limits. If a transaction amount limit is not associated with data received in the authorization request, in step 408, the transaction is processed as normal (i.e., without partial approval). If a transaction amount limit, or multiple transaction amount limits, is associated with the transaction data, the process continues to step 410.

In step 410, the processing server 110 may determine the transaction amount limit, or multiple transaction amount limits, that correspond to the received transaction data. In step 412, the processing server 110 may determine whether the transaction amount associated with the authorization request received in step 404 exceeds any transaction amount limits corresponding to the received transaction data. If the processing server 110 determines that the transaction amount associated with the authorization request received in step 404 does not exceed any transaction amount limits, the transaction is processed as normal (i.e., without partial approval) in step 414. If the transaction amount associated with the authorization request received in step 404 exceeds one or multiple transaction amount limits, then the process continues to step 416.

In step 416, the processing server 110 generates a recommended approval value based upon the transaction amount limits associated with the CPN and received transaction data that are exceeded by the transaction amount associated with the authorization request received in step 404. The recommended approval value may be an amount equal to a single transaction amount limit, less than a single transaction limit, or may be based upon multiple transaction limits.

For example, the received transaction data may include products in a first category that are associated with a first transaction limit and products in a second category that are associated with a second transaction limit. The recommended approval value may be the aggregate of the maximum available amount that can be spent in the first category and the maximum available amount that can be spent in the second category. The recommended approval value may alternatively be a number less than the aggregate of the maximum available amounts that can be spent in the first and second categories. In some instances, the received transaction data may be such that a portion of the transaction data is associated with a transaction amount limit and another portion of the transaction data is not associated with a control specifying a transaction amount limit. In some instances, the received transaction data may include data related to a single product, category of products, merchant, or other data that may be associated with multiple transaction limits. In some instances, transaction data from a single merchant may invoke the application of two or more conditions, wherein each condition may be associated with a different transaction amount limit.

In an exemplary embodiment, transaction data may be received relating to the purchase of a single product. Various budget amounts, or transaction limits, may be associated with the single product, the merchant from which the transaction data is received, the category of product, etc. Each of the budget amounts related to the purchase of the single product may be considered in the determination of the recommended approval value.

The generated recommended approval value of step 416 may take into account some or all transaction limits associated with some or all transaction data received in the authorization request of step 404. Preferably, the generated recommended approval value is a value that, taking into consideration all control conditions applicable to the received transaction data, does not violate any transaction amount limits. The generated recommended approval value may be a single value or multiple values.

In step 418, the processing server 110 updates the authorization request received in step 404 to include one or multiple recommended approval values. These recommended approval values may be included in one or multiple data fields. For instance, two or more recommended approval values may be included in a single data field.

In step 420, a transmitting device (e.g., the transmitting unit 206) of the processing server 110, transmits the updated authorization request to the issuer. The issuer may determine whether to authorize or deny the transaction based upon the updated authorization request. The issuer may then respond to the authorization response.

In step 422, a receiving device (e.g., the receiving unit 202) of the processing server 110, may receive the authorization response. The processing server 110 may then pass the authorization response along to the merchant, in step 424. The authorization response may be transmitted to the merchant either directly or through another entity, such as an acquirer.

It will be apparent to persons having skill in the relevant art that the exemplary process 400 illustrated in FIG. 4 does not constitute the only configuration of the processing server 110 for processing controlled card transactions including partial payment approval. Further, although the steps of process 400 may appear to be described sequentially, some of the steps may in fact be performed concurrently. Additional configurations of the processing server 110 for processing the account controls and payment transactions using the methods and systems discussed herein will be apparent to persons having skill in the relevant art.

Exemplary Method for Partial Payment Approval of Controlled Card Transactions

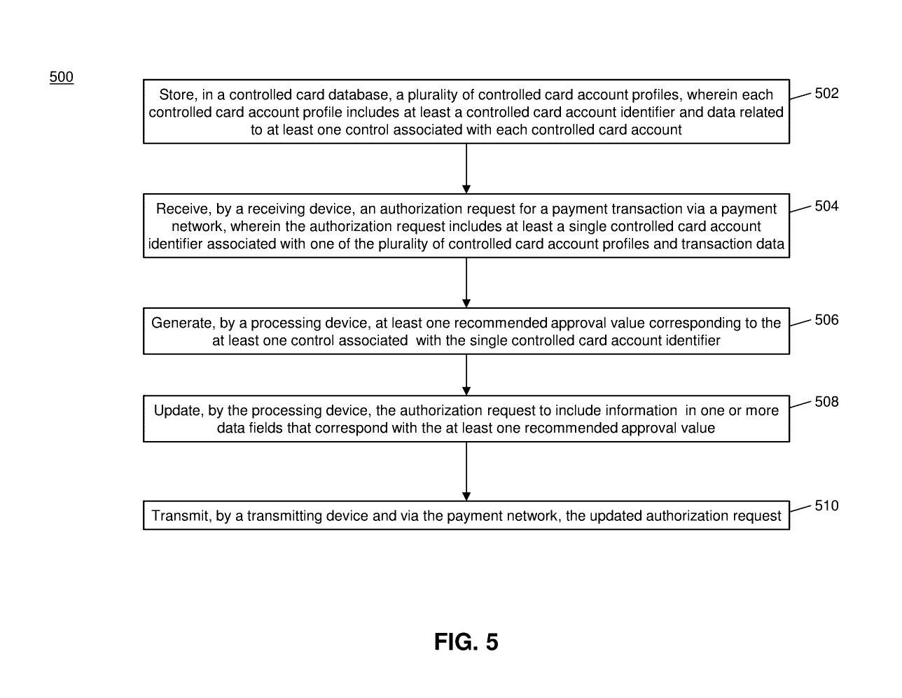

FIG. 5 illustrates an exemplary method 500 for processing partial payment approval for controlled card transactions. In step 502, a plurality of card account profiles (e.g., controlled card account profiles 210) are stored in a database (e.g., controlled card account database 208), wherein each card account profile includes at least a card account identifier (e.g., a CPN) and data related to at least one control associated with each card account profile.

In step 504, an authorization request for a payment transaction is received, by a receiving device (e.g., the receiving unit 202) via a payment network, wherein the authorization request is for a payment transaction and includes at least a card account identifier associated with one of the plurality of card account profiles and transaction data. In step 506, a processing device (e.g., the processing unit 204) may generate at least one recommended approval value based upon at least one of the at least one controls associated with the card account identifier.

In step 508, the processing device may update the authorization request to include information in one or more data fields that corresponds with the at least one recommended approval value. And, in step 510, a transmitting device (e.g., the transmitting unit 206) may transmit the updated authorization request via the payment network.

Computer System Architecture

FIG. 6 illustrates a computer system 600 in which embodiments of the present disclosure, or portions thereof, may be implemented as computer-readable code. For example, the processing server 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radiofrequency (RF), or any combination thereof. Other suitable network types and configurations will be apparent to persons having skill in the relevant art. The computer system 600 may also include a main memory 608 (e.g., random access memory, read-only memory, etc.)and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communication interface 624. The communication interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for retrying processing of controlled payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for enabling partial payment by a controlled card, comprising:
storing, in a controlled card database, a plurality of controlled card account profiles, wherein each controlled card account profile includes at least a controlled card account identifier and data related to at least one control associated with the controlled card account identifier;
receiving, by a receiving device, an authorization request for a payment transaction via a payment network, wherein the authorization request includes at least a single controlled card account identifier associated with one of the plurality of controlled card account profiles and transaction data;
generating, by a processing device, at least one recommended approval value based upon the at least one control associated with the single controlled card account identifier;
updating, by the processing device, the authorization request to include information in one or more data fields that corresponds with the at least one recommended approval value; and
transmitting, by a transmitting device and via the payment network, the updated authorization request.

2. The method of claim 1, wherein the data related to at least one control associated with the controlled card account profile corresponding to the single controlled card account identifier includes at least one transaction amount limit.

3. The method of claim 1, wherein the data related to at least one control associated with the controlled card account profile includes at least a first control associated with a first transaction amount limit and a second control associated with a second transaction amount limit.

4. The method of claim 2, wherein the recommended approval value is one of: an amount equal to one transaction amount limit of the at least one transaction amount limit associated with the single controlled card account identifier and an amount less than the one transaction amount limit of the at least one transaction amount limit associated with the single controlled card account identifier.

5. The method of claim 1, wherein one data field of the one or more data fields includes at least two recommended approval values.

6. The method of claim 5, wherein two of the at least two recommended approval values are an amount equal to one transaction amount limit of the at least one transaction amount limit associated with the single controlled card account identifier and an amount less than the one transaction amount limit of the at least one transaction amount limit associated with the single controlled card account identifier.

7. The method of claim 1, further comprising:
receiving, by the receiving device, an authorization response via a payment network, wherein the authorization response includes at least the single controlled card account identifier associated with one of the plurality of controlled card account profiles; and
transmitting, by the transmitting device and via the payment network, the authorization response.

8. The method of claim 7, wherein the authorization response includes an authorized value corresponding to data included in the one or more data fields.

9. The method of claim 3, wherein the recommended approval amount is one of: the first transaction amount limit, the second transaction amount limit, or an amount based upon both the first transaction amount limit and the second transaction amount limit.

10. The method of claim 1, wherein the single controlled card account identifier is a virtual card number.

11. A system for enabling partial payment by a controlled card, comprising:
a controlled card database configured to store a plurality of controlled card profiles, wherein each controlled card profile includes at least a controlled card account identifier and data related to at least one control associated with each controlled card account;
a receiving device, configured to receive an authorization request for a payment transaction via a payment network, wherein the authorization request includes at least a single controlled card account identifier associated with one of the plurality of controlled card account profiles and transaction data;
a processing device configured to:
generate at least one recommended approval value based upon the at least one control one control associated with the single controlled card identifier, and
update the authorization request to include information in one or more data fields that corresponds with the at least one recommended approval value; and
a transmitting device configured to transmit the updated authorization request via the payment network.

12. The system of claim 11, wherein the data related to at least one control associated with the controlled card account profile corresponding to the single controlled card account identifier includes at least one transaction amount limit.

13. The system of claim 11, wherein the data related to at least one control associated with the controlled card account profile includes at least a first control associated with a first transaction amount limit and a second control associated with a second transaction amount limit.

14. The system of claim 11, wherein the recommended approval value is one of: an amount equal to one transaction amount limit of the at least one transaction amount limit associated with the single controlled card account identifier and an amount less than the transaction amount limit of the at least one transaction amount limit associated with the single controlled card account identifier.

15. The system of claim 11, wherein one data field of the one or more data fields includes at least two recommended approval values.

16. The system of claim 15, wherein two of the at least two recommended approval values are an amount equal to one transaction amount limit of the at least one transaction amount limit associated with the single controlled card account identifier and an amount less than the one transaction amount limit of the at least one transaction amount limit associated with the single controlled card account identifier.

17. The system of claim 11, wherein the receiving device is further configured to receive an authorization response via a payment network, wherein the authorization response includes at least the single controlled card account identifier associated with one of the plurality of controlled card account profiles and wherein the transmitting device is further configured to transmit the authorization response.

18. The system of claim 17, wherein the authorization response includes an authorized value corresponding to data included in the one or more data fields.

19. The system of claim 13, wherein the recommended approval amount is one of: the first transaction amount limit, the second transaction amount limit, or an amount based upon both the first transaction amount limit and the second transaction amount limit.

20. The system of claim 11, wherein the single controlled card account identifier is a virtual card number.
